(19) United States
(12) Patent Application Publication
(10) Pub. No.: US 2012/0075193 A1
(43) Pub. Date: Mar. 29, 2012

(54) MULTIPLEXED NUMERIC KEYPAD AND TOUCHPAD

(75) Inventors: Randal J. Marsden, Edmonton (CA); Steve Hole, Edmonton (CA)

(73) Assignee: Cleankeys Inc., Edmonton (CA)

(21) Appl. No.: 13/308,428

(22) Filed: Nov. 30, 2011

Related U.S. Application Data
(63) Continuation-in-part of application No. 12/234,053, filed on Sep. 19, 2008.
Application No. 12/234,053 is a continuation-in-part of application No. 13/171,124, filed on Jun. 28, 2011.
(60) Provisional application No. 60/973,691, filed on Sep. 19, 2007.
(60) Provisional application No. 61/359,235, filed on Jun. 28, 2010.
(60) Provisional application No. 61/418,279, filed on Nov. 30, 2010.
(60) Provisional application No. 61/472,799, filed on Apr. 7, 2011.

(51) Int. Cl. G06F 3/041; G06F 3/02

(52) U.S. Cl. 345/168

(57) ABSTRACT

A method and system that integrates a numeric keypad with a touchpad in the same physical location on a touch-sensitive display device. Operational mode of the same location is automatically determined based on user actions with the display or based on a manual entry by the user. The system operates in at least one mode of operation selected from: numpad mode, touchpad mode, keyboard mode and auto-detect mode. A visual indicator communicates with the user which mode is the current mode.

### PRIORITY CLAIM

This application is a Continuation-in-Part of U.S. Utility application Ser. No. 12/234,053 filed Sep. 19, 2008, which claims the benefit of U.S. Provisional Application Ser. No. 60/973,691 filed Sep. 19, 2007, and is a Continuation-in-Part of U.S. Utility application Ser. No. 13/171,124 filed Jun. 28, 2011, which claims the benefit of U.S. Provisional Application Ser. No. 61/359,235 filed Jun. 28, 20101.

This application claims the benefit of U.S. Provisional Application Ser. Nos. 61/418,279 filed Nov. 30, 2010, and 61/472,799, filed Apr. 7, 2011, which are hereby incorporated by reference.

### FIELD OF THE INVENTION

The invention relates to a smooth touch-sensitive surface that allows the user to rest their hands or fingers on the surface without causing an event actuation. More specifically, the touch surface may be made up of both a keypad and a touchpad occupying the same physical space.

### BACKGROUND OF THE INVENTION

The origin of the modern keyboard as the primary method for inputting text and data from a human to a machine dates back to early typewriters in the 19th century. As computers were developed, it was a natural evolution to adapt the typewriter keyboard to be used as the primary method for inputting text and data. While the implementation of the keys on a typewriter and subsequently computer keyboards have evolved from mechanical to electrical and finally to electronic, the size, placement, and mechanical nature of the keys themselves have remained largely unchanged.

As computers evolved and graphical user interfaces were developed, the mouse pointer became a common user input device. With the introduction of portable “laptop” computers, various new pointing devices were invented as an alternative to the mouse, such as trackballs, joysticks, and touchpads (also referred to “trackpads”). The overwhelming majority of laptop computers now incorporate the touchpad as the primary pointing device.

Prior to computers, a common office instrument used for performing numerical calculations was the “adding machine”. This device incorporated number keys along with common mathematical operation keys, such as add, subtract, multiply and devide. The operator would perform data entry on these machines, which then display the result, print the result, or do both. Experienced operators of adding machines were able to memorize the location of the keys and enter data and perform operations very quickly without looking As computers became common, the need for efficient numeric entry persisted and the “adding machine” functions were added to computer keyboards in the form of a numeric keyboard (or “numpad”) typically located to the right of the standard keyboard.

Combining the three primary user interface devices of keyboard, touchpad, and numpad into a single device results in the device becoming unreasonably large. The problem is further complicated by the fact that many modern keyboards incorporate yet additional keys for page navigation, multimedia controls, gaming, and keyboard settings functions. The result can be a “keyboard” that is often larger than the computer itself.

### SUMMARY OF THE INVENTION

The present invention describes a method and system that solves the space problem by integrating the numeric keypad part of the keyboard and the touchpad in the same physical location.

Keyboard technology has now evolved to the point of eliminating the traditional mechanical keys, in favor of a touch-sensitive surface that can detect user input through the correlation of touch and vibration sensors (Marsden, U.S. patent application Ser. No. 12/234,053). This surface can be used to provide all the functions of the keyboard, numpad, and touchpad, but in a much smaller space since it makes it possible to “multiplex” or use the same physical space on the surface for multiple functions. The touch surface may incorporate either a dynamic or static display beneath it, or a mixture of both.

In aspect of the invention, the numeric keypad and the touchpad occupy the same physical space. This is possible due to the fact that the touch-sensitive surface, unlike traditional mechanical keys, can have the spacing, size, orientation, and function of its “keys” dynamically assigned.

In another aspect of the invention, the system has three modes of operation: numpad mode, touchpad mode, and auto-detect mode. A visual indicator communicates with the user which mode it is in. The user changes the mode via activation of a key or key combinations on the keyboard. Visual indicators provide feedback to the user as to which mode the device is in.

In a further aspect of the invention, the system automatically determines which mode the user intends based on their interaction with the touch surface. For example, if the user slides their finger across the surface, they most likely intend for it to act as a touchpad, causing the pointer to move. Similarly, if the user taps their finger on a specific sector of the touch surface assigned to a number key, then they most likely intend for it to be used as a numpad.

### BRIEF DESCRIPTION OF THE DRAWINGS

Preferred and alternative examples of the present invention are described in detail below with reference to the following drawings:

FIG. 1 is a hardware block diagram showing the typical hardware components of a system formed in accordance with an embodiment of the present invention;

FIG. 2 shows an exemplary process performed by the system shown in FIG. 1; and

FIG. 3 is a schematic parital view of an exemplary touch sensitive surface formed in accordance with an embodiment of the present invention.

### DETAILED DESCRIPTION OF THE PREFERRED EMBODIMENT

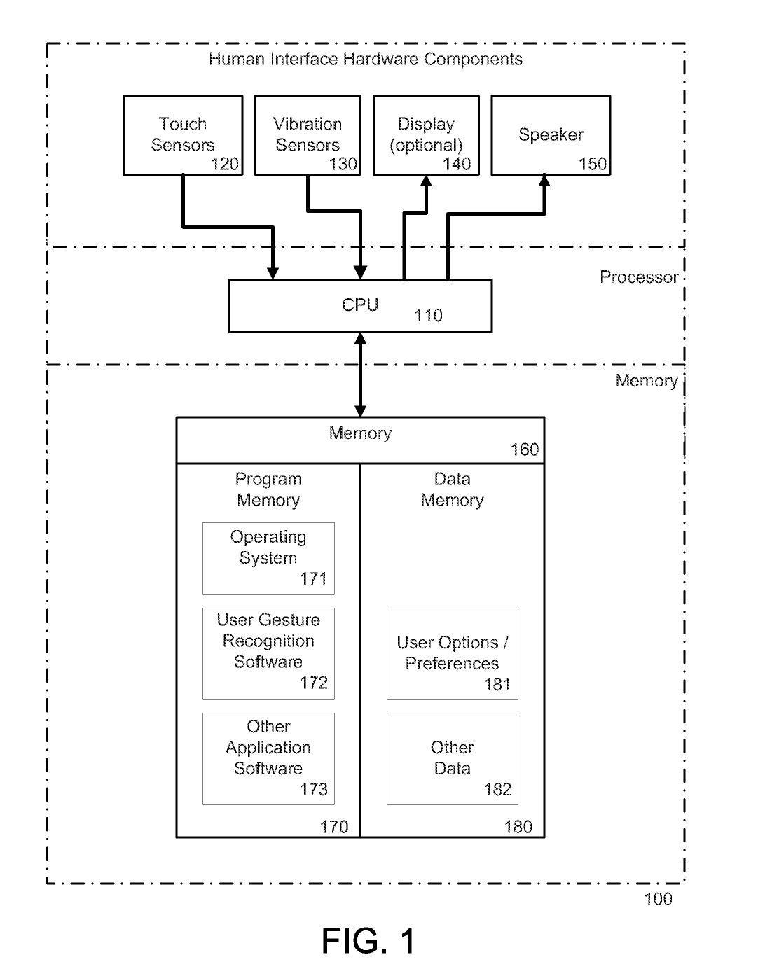

FIG. 1 shows a block diagram of the hardware components of a device 100 for providing a multiplexed numeric keypad and touchpad. The device 100 includes one or more touch sensors 120 that provides input to a CPU (processor) 110 notifying the processor 110 of contact events when the surface has been touched, typically mediated by a hardware controller that interprets the raw signals received from the touch sensor(s) 120 and communicates the information to the processor 110 using a known communication protocol via an available data port. Similarly, the device 100 includes one or more vibration sensors 130 that communicate with the processor 110 when the surface is tapped, in a manner similar to that of the touch sensor(s) 120. The processor 110 communicates with an optional hardware controller to cause a display 140 to present an appropriate image. A speaker 150 is also coupled to the processor so that any appropriate auditory signals can be passed on to the user as guidance. The processor 110 has access to a memory 160, which may include a combination of temporary and/or permanent storage, and both read-only and writable memory (random access memory or RAM), read-only memory (ROM), writable non-volatile memory such as FLASH memory, hard drives, floppy disks, and so forth. The memory 160 includes program memory 170 that contains all programs and software such as an operating system 171, the User Gesture Recognition software 172, and any other application programs 173. The memory 160 also includes data memory 180 that includes user options and preferences 181 required by the User Gesture Recognition software 172, and any other data 182 required by any element of the device 100.

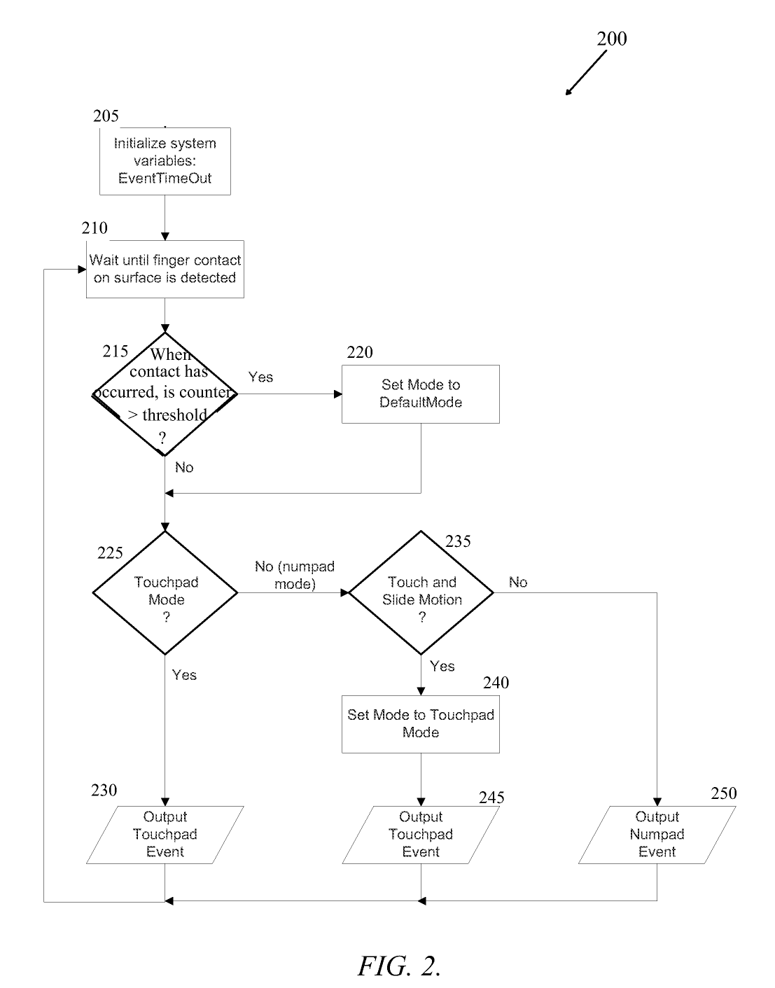

FIG. 2 shows a flow chart of an exemplary process 200 that allows the same physical area on a touchscreen keyboard to be used to perform the functions of both a numeric keypad and touchpad. The process 200 is not intended to fully detail all the software of the present invention in its entirety, but is provided as an overview and an enabling disclosure of the present invention.

The process 200 is provided by the User Gesture Recognition Software 172. At block 205, when the process is first started, various system variables are initialized. For example, event time out (threshold time) is set to zero. At block 210, the process waits to be notified that user contact has occurred within the common area. While the system is waiting in block 210, a counter is incremented with the passage of time. Once user contact has occurred, block 215 determines if the counter has exceeded the maximum time (threshold) allowed for user input (stored as a user option in Data Memory 181).

If the maximum time allowed for user input has been exceeded, then the system resets the mode of the common area to the default mode in block 220. At a decision block 225, the processor 110 determines whether or not the current mode is in touchpad mode. If the current mode is in the touchpad mode, the processor 110 interprets the user contact as a touchpad event and outputs the command accordingly in block 230.

If the current mode is not in the touchpad mode, then the processor 110 assumes the common area is in number pad (numpad) mode and proceeds to decision block 235. In touchpad operation, the user will make an initial touch followed by a sliding motion with their finger (or multiple fingers). In numpad operation, the user will tap on a number key and typically will not slide their finger. The processor 110 uses this difference in typical operation to interpret the user's input in decision block 235 and if a touch-and-slide motion is detected by the processor 110 based on signals provided by the sensors 120,130, the processor 110 changes the current mode to the touchpad mode in block 240, and outputs the user action as a touchpad event in block 245. If the user action is not a touch-and-slide motion then the user action is output by the processor 110 as a numpad event in block 250. After blocks 230, 245, 250, the process 200 returns to block 210.

Note that single taps (or multiple taps in succession) are also common when using a touchpad, and are commonly assigned to functions such as “select” or what is commonly referred to as a “mouse left button” action. These types of actions typically occur shortly after a touch-and-slide motion, and so the system will still be in touchpad mode (since the counter will not yet have reached the threshold in block 215).

Other user gestures on the touchpad are interpreted and assigned to functions, such as multiple finger swipes across the touchpad. While the device 100 is in the touchpad mode, all these gestures are interpreted as touchpad input and sent to the device's operating system as such to be interpreted by whatever system software resides therein. In this way, the system and method of the present invention acts exactly like any other touchpad when in touchpad mode.

In one embodiment, the default mode is set by the user (typically through control panel software). If the device 100 is at rest with no user input for the user-settable amount of time (threshold), the mode is restored to the default mode.

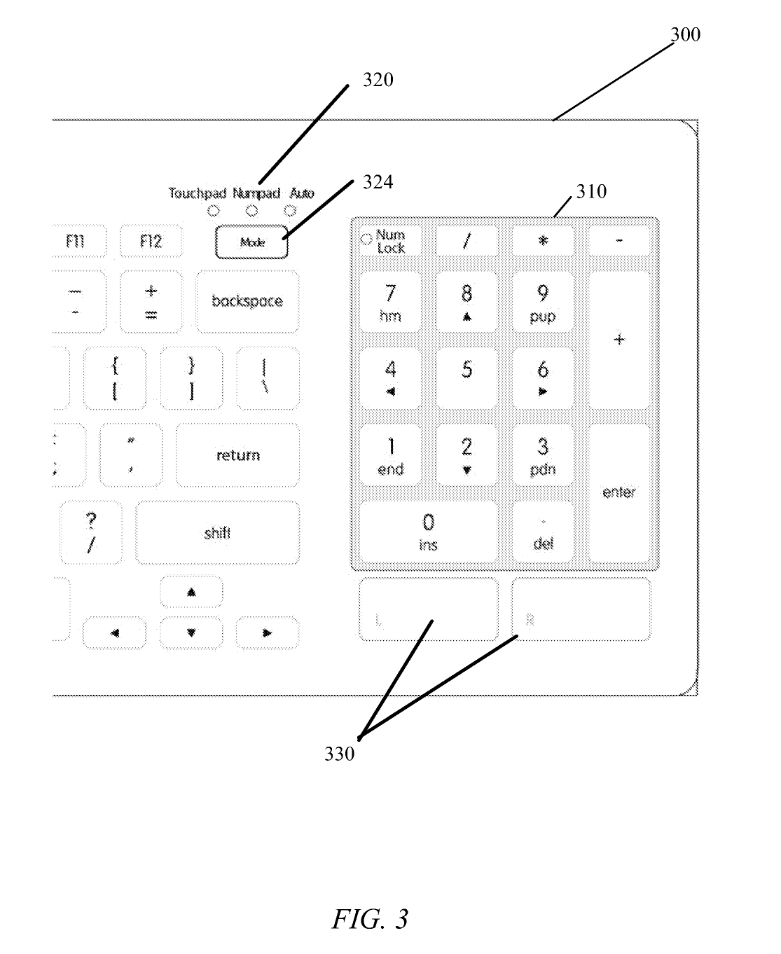

FIG. 3 shows a schematic view representative of a touch and tap-sensitive keyboard 300 that incorporates on its forward-facing surface an area 310 incorporating the functions of both a numeric keypad and touchpad. The term “keyboard” in this application refers to any keyboard that is implemented on a touch and tap sensitive surface, including a keyboard presented on a touch-sensitive display. The keyboard 300 includes the outline of the area 310 incorporating the functions of the touchpad, the keys assigned to the numeric keypad, as well as the selection keys commonly referred to as the “left and right mouse buttons” 330. “Mode” refers to the type of function that is assigned to the commonly-shared area 310. A separate mode key 320 allows the user to manually select between Touchpad mode, numeric keypad (or “numpad”) mode, or “Auto” mode (whereby the function assigned to common area 310 is determined by the system according to the actions of the user on the surface of the common area 310).

In one embodiment, the system of the present invention displays the current mode (touchpad or number pad) with visual indicators 320 along with an “Auto” mode visual indicator. In this way, the user can know which mode the system is in at all times. In one embodiment, a mode key 324 is provided below the indicators 320 on the keyboard. User activation of the mode key 324 causes the processor 110 to switch to another mode.

In one embodiment, the user may define the default mode to be the touchpad mode by first selecting Auto mode with the mode key 324 immediately followed by a touch-and-slide motion on the common area 310. In the absence of a touch-and-slide motion immediately following the selection of Auto mode, the processor 110 will set the default mode to numpad mode.

In another embodiment of the invention, the touch surface is used in a fourth mode: keyboard. In the fourth mode, the surface represents a keyboard, on which the user may enter text using a plethora of methods designed for smaller touch surfaces (such as those invented for smartphones). This mode is manually selected by the user through some scheme implemented on the keyboard or computer software, or it is selected by functionality provided by the auto-detect mode. The device stays in keyboard mode for as long as the user is typing. To exit the keyboard mode and return to the touchpad mode, the user performs a predefined gesture—such as pressing and holding all their fingers for a few seconds in the same location. The processor recognizes the unique gesture, then changes mode accordingly. Other gestures could also be recognized.

In another embodiment of the invention, the touch surface incorporates a dynamic display. The display changes in accordance with the current mode setting to display the appropriate image in the common area. For example, when numpad mode is selected, a numeric keypad is displayed; when touchpad is selected, a blank rounded rectangle is displayed; and so on.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

The embodiments of the invention in which an exclusive property or privilege is claimed are defined as follows:

1. A system comprising:
a surface comprising a multi-mode area;
a plurality of touch sensors coupled to the surface, the plurality of touch sensors configured to generate at least one sense signal based on sensed user contact with the surface;
a plurality of motion sensors, the plurality of motion sensors configured to generate a motion signal based on sensed vibrations of the surface; and
a processor in signal communication with the surface, the plurality of touch sensors, and the plurality of motion sensors, wherein the processor is configured to determine mode of operation associated with the multi-mode area based on interpretation of at least one of the generated at least one sense signal and the motion signal associated with the multi-mode area.

2. The system of claim 1, wherein the modes of operation comprise at least two of a keyboard mode, a numeric keypad mode, or a touchpad mode.

3. The system of claim 2, wherein the processor is further configured to determine the mode of operation based on a signal associated with a user selection.

4. The system of claim 3, wherein the surface comprises a display device coupled to the processor, wherein the user selection comprises activation of a mode key displayed by the processor on the surface.

5. The system of claim 1, wherein the surface comprises at least one visual indicator, wherein the processor illuminates at least one visual indicator based on the determined mode of operation.

6. The system of claim 2, wherein the processor identifies a default mode of operation.

7. The system of claim 6, wherein the processor identifies the default mode of operation to be the touchpad mode after an auto mode selection has occurred followed within a predefined amount of time by a determination of a sliding motion at least on or near the multi-mode area based on the at least one sense signal,
wherein the processor identifies the default mode to be the numeric keypad mode if after the auto mode selection no sliding motion is detected within the predefined amount of time based on the at least one sense signal.

8. The system of claim 6, wherein the processor determines mode of operation to be the touchpad mode, if the processor detects a touch-and-slide motion at the multi-mode area based on the generated at least one sense signal and the motion signal,
wherein the processor determines mode of operation to be at least one of the numeric keypad mode or the keyboard mode, if the processor detects only a tap motion based on the generated motion signals and the detected tap motion did not occur within a threshold amount of time since the detected touch-and-slide motion.

9. The system of claim 8, wherein the processor returns interpretation of the generated at least one sense signal and the motion signal associated with the multi-mode area to the default mode after a predefined period of time has expired since a previously generated at least one sense signal and motion signal associated with the multi-mode area.

10. The system of claim 2, wherein the surface comprises a display device coupled to the processor,
wherein the processor is configured to generate an image and present the generated image in the multi-mode area of the surface, wherein the generated image is associated with current mode of operation.

11. The system of claim 1, wherein the surface comprises a static representation of at least one of a numeric keypad, keyboard or touchpad.

12. A method comprising:
at a plurality of touch sensors, generating at least one sense signal based on sensed user contact with a surface;
at a plurality of motion sensors, generating a motion signal based on sensed vibrations of the surface; and
at a processor in signal communication with the surface, the plurality of touch sensors, and the plurality of motion sensors,
receiving the generated at least one sense signal and the motion signal; and
determining mode of operation associated with a multi-mode area of the surface based on interpretation of at least one of the received at least one sense signal and the motion signal associated with the multi-mode area.

13. The method of claim 12, wherein the modes of operation comprise at least two of a keyboard mode, a numeric keypad mode, or a touchpad mode.

14. The method of claim 13, wherein determining the mode of operation comprises determining the mode of operation based on a signal associated with a user selection.

15. The method of claim 12, further comprising at the processor illuminating at least one visual indicator associated with the surface based on the determined mode of operation.

16. The method of claim 13, further comprising at the processor identifying a default mode of operation.

17. The method of claim 16, wherein identifying comprises:
identifying the default mode of operation is the touchpad mode after receiving an auto mode selection followed within a predefined amount of time by receiving at least one sense signal determined to be a sliding motion at least on or near the multi-mode area; and
identifying the default mode is the numeric keypad mode if after receiving the auto mode selection no sense signal determined to be a sliding motion is received within the predefined amount of time.

18. The method of claim 16, wherein determining mode of operation comprises:
determining the mode of operation is the touchpad mode, if a touch-and-slide motion at the multi-mode area has been detected based on the generated at least one sense signal and the motion signal,
determining the mode of operation is at least one of the numeric keypad mode or the keyboard mode, if only a tap motion has been detected based on the generated motion signals and the detected tap motion did not occur within a threshold amount of time since the detected touch-and-slide motion.

19. The method of claim 18, further comprising at the processor returning interpretation of the generated at least one sense signal and the motion signal associated with the multi-mode area to the default mode after a predefined period of time has expired since a previously generated at least one sense signal and motion signal associated with the multi-mode area.

20. The method of claim 13, further comprising at the processor:
generating an image based on current mode of operation; and
presenting the generated image in the multi-mode area of the surface.
